(19) United States
(12) Patent Application Publication
(10) Pub. No.: US 2003/0100263 A1
(43) Pub. Date: May 29, 2003

(54) Portable electrical device having a detachable input unit

(75) Inventors: Kenichi Tanaka, Sagamihara-shi (JP); Hideyuki Usui, Chigasaki-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/283,967

(22) Filed: Oct. 30, 2002

(30) Foreign Application Priority Data
Oct. 30, 2001 (JP) 2001-332324

(51) Int. Cl. H04B 7/24; H04B 5/00; H04B 7/00; G09G 5/00

(52) U.S. Cl. 455/41; 345/156; 345/168; 455/66

(57) ABSTRACT

The invention relates to an electrical device, of which one example is a laptop-type PC provided with a PC body and a keyboard configured as an input unit to be detachable from the PC body. Such a PC is equipped with the detachable keyboard which can be used either in a wired system or a wireless system in a state separated from the PC body. The invention allows for the input unit to automatically switch between wired and wireless operation depending on the state of connectivity between the input unit and the electrical device. The invention also provides at least two different, advantageous positions of wired integration between the input unit and the electrical device.

### FIELD OF THE INVENTION

The present invention relates to electrical devices having input units and more specifically to a portable electrical device, such as a laptop-type provided with an input unit configured to be detachable from the electrical device.

### BACKGROUND OF THE INVENTION

Usually, in a personal computer (hereinafter abbreviated to PC), especially a desktop type PC, among other types of electrical devices, the PC body, the display unit and the keyboard are configured separately from one another. The PC body and the display unit are connected to each other by cables for the communication of information, and so are the PC body and the keyboard. In recent years, a keyboard utilizing a wireless system has come to be increasingly used in PCs, particularly desktop type PCs. Such a keyboard utilizing a wireless system is provided with a wireless unit between the PC body and the keyboard, and is so structured that information from the keyboard to the PC body is communicated by infrared rays or radio waves.

Advantages of a keyboard utilizing a wireless system consist in that cumbersome cables are not stretched, leaving ample working space, and that setting-up is simplified because no wiring is needed. However, the keyboard utilizing a wireless system described above involves the problems that, depending on the location and orientation of the keyboard, communication with the PC body can become impossible, making the PC unusable, and that discharging of the battery, used as the power source, would also make the PC unusable.

In a laptop-type PC, however, (herinafter referred to as a laptop PC or a notebook PC) the PC body, the display unit and the keyboard are usually put together in an integrated configuration. In this respect, as a laptop type PC is essentially light enough to be portable, there was no idea for separating the keyboard alone from the PC body. In recent years, however, along with the diversification in the modes of PC use, there has emerged a rising call for detachability of the keyboard from the PC body even for laptop type PCs. Separation of the keyboard alone by utilizing a wireless system would provide a similar benefit to the laptop type PC as was described above with respect to the desktop type PC, however, a similar disadvantage to the aforementioned would also arise.

Therefore, an object of the present invention is to solve the problems noted above, and to provide a portable electrical device having a detachable input unit which can overcome the disadvantages of the wireless system, such as inability to communicate and unusability due to the discharging of the battery while retaining the advantages of the wireless system including freedom from the stretching of cumbersome cables, availability of ample working space, and a simplified setting-up procedure by virtue of the absence of wiring need.

### SUMMARY OF THE INVENTION

An electrical device having a detachable input unit according to the present invention is provided with an electrical device body and an input unit configured to be detachable from this electrical device body. This electrical device is equipped with an input unit capable of being used either in a wired system or a wireless system in a state separated from the electrical device body.

The invention makes it possible, by virtue of the input unit detachable from the electrical device body and compatible with both wireless and wired systems, to overcome the disadvantages of the traditional wireless system, such as inability to communicate and unusability due to the discharging of the battery, while retaining the advantages of the wireless system including freedom from the stretching of cumbersome cables, availability of ample working space, and a simplified setting-up procedure because of the absence of wiring need.

Specific preferred embodiments of the invention include a configuration in which the input unit can switch between wired and wireless connection in a state separated from the electrical device body automatically by the plugging in and out of a cable, another in which the wireless unit on the input unit side and the wireless unit on the electrical device body side are suspended from operation when used in a wired system, and still another in which the electric power for the input unit is supplied from the electrical device body via a cable operation when used in a wired system. In any of these configurations, the invention can be carried out even more advantageously.

Other specific preferred embodiments of the invention include a configuration in which the electrical device body of the electrical device of the above-described configuration has a first interface for communicating with the input unit when arranged in a first position to engage the input unit with the electrical device body and a second interface for communicating with the input unit when arranged in another second position to engage the input unit with the electrical device body, and another in which the input unit has a first interface for communicating with the electrical device body when arranged in a first position to engage the input unit with the electrical device body and a second interface for communicating with the electrical device body when arranged in another second position to engage the input unit with the electrical device body. In any of these configurations, the input unit of the electrical device can be operated even more efficiently.

Still other specific preferred embodiments of the invention include a configuration having a first position for integration of the detachable input unit and the electrical device body with each other to be made portable, and another having a second position for use of the electrical device with part of the input unit being engaged with part of the electrical device body and another part of the input unit being separated from the electrical device body.

### BRIEF DESCRIPTION OF THE DRAWINGS

Hereafter, the present invention will be described in detail in accordance with the embodiment(s) shown in the accompanying drawings where the same reference numerals are used to describe the same elements throughout the drawings, and in which:

FIGS. 1A and 1B illustrate an example of a laptop PC as an electrical device having a detachable input unit according to the present invention;

FIG. 2 illustrates an example of wireless system in a state in which the keyboard is separated from the PC body;

FIG. 3 illustrates an example of wired system in a state in which the keyboard is separated from the PC body;

FIGS. 4A through 4C illustrate another example of an electrical device having a detachable input unit according to the invention;

FIGS. 5A through 5C show profiles of states of connection between a keyboard and a PC body in a connected position, an inclined position and a separated position, respectively;

FIG. 6 illustrates one example of state of connection between the keyboard and the PC body; and

FIG. 7 illustrates another example of state of connection between the keyboard and the PC body.

### DETAILED DESCRIPTION OF THE INVENTION

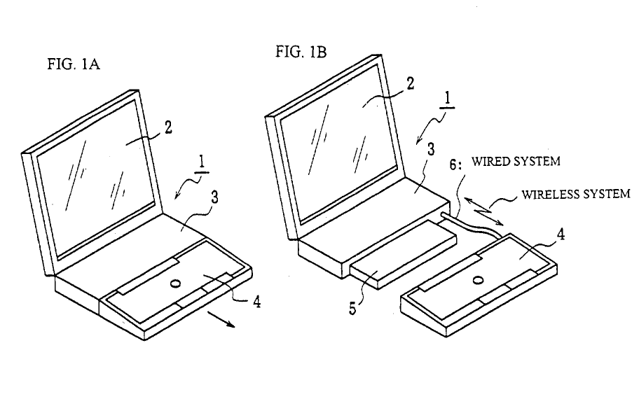

While the following description refers to, by way of example, a laptop type PC having a detachable keyboard to which the invention can be suitably applied, the invention can obviously be applied effectively to other appropriate electrical devices as well. In FIGS. 1A and 1B, a laptop type PC 1 is composed of a PC body 3 provided with a display unit 2 and a keyboard 4 configured to be detachable from this PC body 3. The example as shown in FIG. 1A is in an integrated state in which the keyboard 4 is fitted to the PC body 3. The example as shown in FIG. 1B is in a separated state in which the keyboard 4 is detached from the PC body 3.

In the state of the example shown in FIG. 1B, the PC body 3 is provided with a forward protruded part 5. By engaging this forward protruded part 5 with a concave part (not shown) of the keyboard 4, the keyboard 4 and the PC body 3 are integrated as shown in FIG. 1A. The forward protruded part 5 is also provided with a connector. The configuration is such that the keyboard 4 and the PC body 3, when they are integrated as shown in FIG. 1A, can exchange information between each other via the connector (not shown). The state illustrated in FIG. 1B is one example of a wired system in which the PC body 3 and the keyboard 4 are connected to each other by a cable 6. When the PC is to be used as a wireless system, the cable 6 is removed, and information is exchanged between the PC body 3 and the keyboard 4 via a wireless unit (not shown) provided on both of the PC body 3 and the keyboard 4.

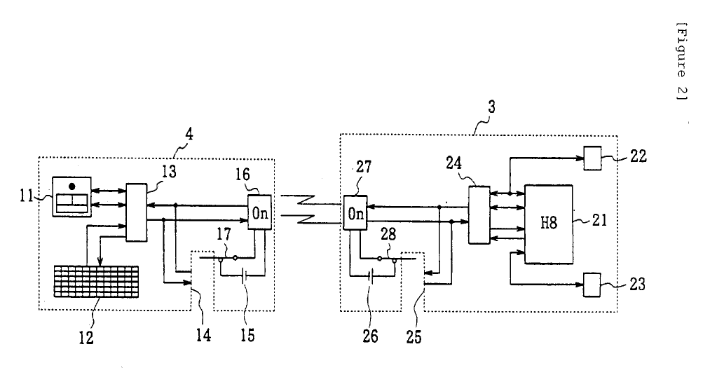

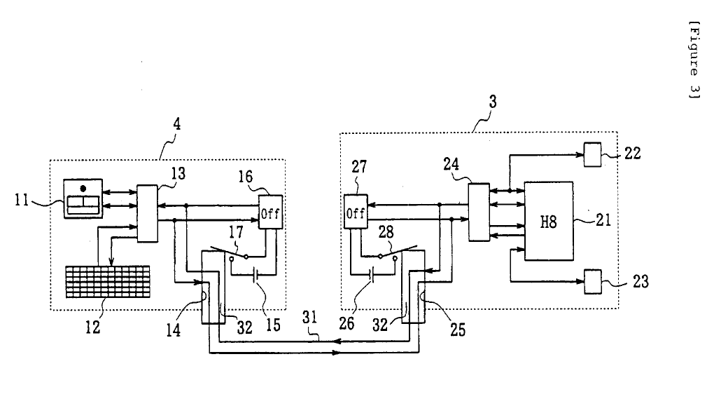

FIG. 2 and FIG. 3 respectively show examples of separation of the keyboard 4 from the PC body 3 as in FIG. 1A. In the example shown in FIG. 2, a wireless system is used, and in the example shown in FIG. 3, a wired system is used. In the examples shown in FIG. 2 and FIG. 3, the keyboard 4 is provided with a pointing device 11, a key input unit 12, a signal converting unit 13, a jack 14, a power source 15, a wireless unit 16 and a power switch 17. The PC body 3 is provided with a controller chip 21, an external mouse connector 22, an external keyboard connector 23, a signal converting unit 24, a jack 25, a power source 26, a wireless unit 27 and a power switch 28.

In the wireless system shown in FIG. 2, the power switch 17 of the keyboard 4 and the power switch 28 of the PC body 3 are closed, and the wireless unit 16 of the keyboard 4 and the wireless unit 27 of the PC body 3 are turned on. In this state, information from the pointing device 11 and the key input unit 12 of the keyboard 4 is conveyed to the wireless unit 16 via the signal converting unit 13 and externally supplied as, for instance, a radio wave signal. The radio wave signal supplied from the keyboard 4 is received by the wireless unit 27 of the PC body 3, and the received signal is conveyed to the controller chip 21 via the signal converting unit 24. From the controller chip 21, information is sent to the pointing device 11 of the keyboard 4 and parts (not shown) in the PC body 3, which require information from the key input unit 12. It is obviously also possible to convey information in the reverse direction, i.e. from the PC body 3 to the keyboard 4. Those of reasonable skill in the releavant arts will readily recognize that information can be conveyed between the wireless units 16 and 27 using any known or later-developed method of transmitting and receiving information wirelessly and that the present invention is in no way limited to the use of techniques employing radio waves or infra-red light.

In the wired system shown in FIG. 3, plugs 32 provided at the two ends of a cable 31 are inserted into the jack 14 of the keyboard 4 and the jack 25 of the PC body 3 for wire connection of the keyboard 4 to the PC body 3. When the plugs 32 are inserted into the jacks 14 and 25, the power switches 17 and 28 are opened, and the wireless unit 16 of the keyboard 4 and the wireless unit 27 of the PC body 3 are turned off. In this state, information from the pointing device 11 of the keyboard 4 and the key input unit 12 is conveyed to the controller chip 21 via the signal converting unit 13, the cable 31 and the signal converting unit 24. From the controller chip 21, information is sent to the pointing device 11 of the keyboard 4 and parts (not shown) in the PC body 3, which require information from the key input unit 12. It is obviously also possible to convey information in the reverse direction, i.e. from the PC body 3 to the keyboard 4. To the keyboard 4 is fed, as required, power from the source in the PC body 3 via the cable 31.

In the above-described examples shown in FIG. 2 and FIG. 3, switching between wired and wireless links in a state wherein the keyboard 4 is detached from the PC body 3 can be automatically accomplished by inserting the plugs 32 of the cable 31 into, or pulling them out of as the case may be, the jack 14 of the keyboard 4 and the jack 25 of the PC body 3. When the PC is used with a wired link as shown in FIG. 3, control can be so effected as to stop the operations of the wireless units 16 and 27 of the keyboard 4 and the PC body 3, respectively, and to feed power for the keyboard 4 from the PC body 3 via the cable 31. While radio waves were taken up as examples of information conveying media between the wireless units 16 and 27 in the above-described instances, some other media than radio waves, such as infrared rays, can be used as well. Further, although an example in which the plugs 32 are provided at the two ends of the cable 31 is shown above, it is also possible to connect a cable directly to either one of the keyboard 4 and the PC body 3 and to provide a plug 32 only on the other end.

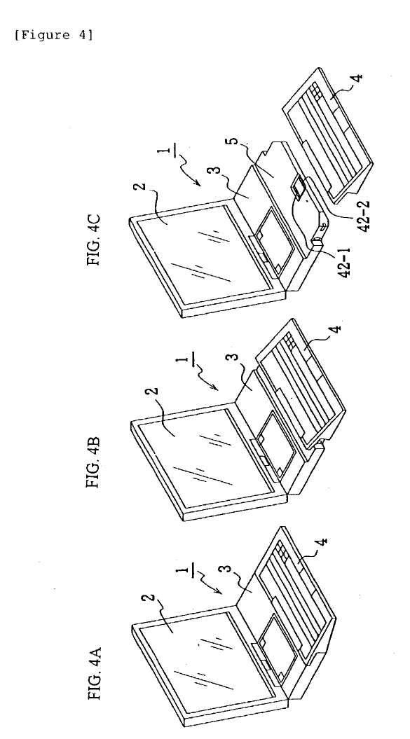

In the example shown in FIGS. 4A through C, the same members as their counterparts in FIGS. 1A and 1B are denoted by the same reference numerals, respectively, and their description is omitted. Regarding the example shown in FIG. 4A through C, FIG. 4A illustrates a connected position in which the keyboard 4 is completely fixed to the PC body 3; FIG. 4B, an inclined position in which the keyboard 4 is slid toward the user from the connected position and inclined in a position where it has ended sliding; and FIG. 4C, a separated position in which the keyboard 4 is completely separated from the PC body 3. This possibility for the user to choose any desired one out of the three positions, including the connected, inclined and separated positions, enables the user to diversify his or her working posture in operating the keyboard 4 and the operation of the keyboard 4 of the laptop type PC 1 to be made even more efficient. Especially in the inclined position shown in FIG. 4B, when operating the keyboard 4, the user can utilize the desk as a palm rest and obtain an ideal inclination angle of the keyboard 4.

In the connected position shown in FIG. 4A and the inclined position shown in FIG. 4B out of the three relative positions of the keyboard 4 and the PC body 3 shown in FIGS. 4A through 4C, including the connected, inclined and separated positions, positioning and electrical connection between the keyboard 4 and the PC body 3 are accomplished via the portion in which they come into contact with each other. In the separated position shown in FIG. 4C, a keyboard 4 utilizing both the wired system and the wireless system shown in FIG. 1 through FIG. 3 can be used. The following description will concern the connection, which has not been described so far, between the keyboard 4 and the PC body 3 in the connected and inclined positions.

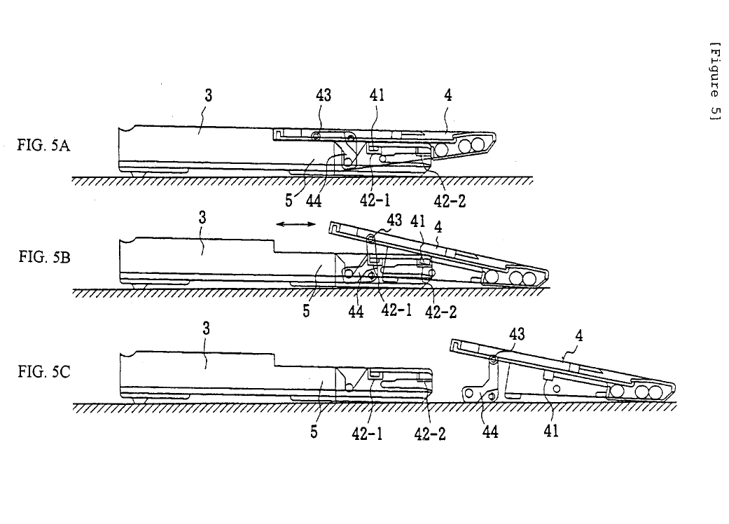

FIGS. 5A through 5C are respectively profiles of the keyboard 4 and the PC body 3 in the three positions described above. FIG. 5A illustrates an example of connected position; FIG. 5B, an example of inclined position; and FIG. 5C, an example of separated position. In the examples shown in FIGS. 5A through 5C, positioning and electrical connection between the keyboard 4 and the PC body 3 are accomplished for two positions with the exception of the separated position, i.e. for the connected and inclined positions, by the use of a male connector 41 provided near the center of the back side of the keyboard 4 and female connectors 42-1 and 42-2 provided near the center of the forward protruded part 5 of the PC body 3. The relationship between the female connectors 42-1 and 42-2 is such that the connector 42-1 is farther from, and the connector 42-2 is closer to, the user. In particular the connector 42-2 is arranged near the edge of the forward protruded part 5 to incline the keyboard 4. Regarding the positions of arranging the male connector 41 and the female connectors 42-1 and 42-2, in order to partly engage the keyboard 4 and the PC body 3 with each other as shown in FIG. 5B and to use the keyboard 4 in an inclined state, it is preferable to arrange them near the center in the longitudinal direction of the keyboard 4 and the forward protruded part 5 denoted by both arrows as shown in FIG. 5B, but there is no particular limitation on their positions in the lateral direction (the direction normal to FIG. 5B).

In the connected position shown in FIG. 5A, the male connector 41 of the keyboard 4 and the female connector 42-1 of the forward protruded part 5 are connected to each other to position, and establish electrical connection between, the keyboard 4 and the PC body 3. In the inclined position shown in FIG. 5B, the male connector 41 of the keyboard 4 and the female connector 42-2 of the forward protruded part 5 are connected to each other to position, and establish electrical connection between, the keyboard 4 and the PC body 3. In the inclined position shown in FIG. 5B, an inclined positioning member 44 is provided, rotatable by a hinge 43 on the back side of the keyboard 4. This inclined positioning member 44 rotates around the hinge 43 to rise from its folded position in the connected position shown in FIG. 5A, works in conjunction with the part where a tip of the keyboard 4 comes into contact with the desk, and thereby fixes the keyboard 4 at a certain angle of inclination relative to the PC body 3. This inclined positioning member 44 is also used for keeping the angle of inclination of the keyboard 4 constant in the separated position shown in FIG. 5C as well.

In the examples shown in FIGS. 4A through 4C and FIGS. 5A through 5C, one example of first position for engaging the PC body 3 with the keyboard 4 is the aforementioned connected position, while one example of second position for engaging the PC body 3 with the keyboard 4, different from the first, is the aforementioned inclined position. The male connector 41 of the keyboard 4 and the female connector 42-1 of the PC body 3 match a first interface for use in communication between the PC body 3 and the keyboard 4, while the male connector 41 of the keyboard 4 and the female connector 42-2 of the PC body 3 match a second interface for use in communication between the PC body 3 and the keyboard 4. Further, one example of the position to integrate the keyboard 4 and the PC body 3 for portability matches the connected position shown in FIG. 5A, while one example of the position to engage part of the keyboard 4 with part of the PC body 3 and to use another part of the keyboard 4 isolated from the PC body 3 matches the inclined position shown in FIG. 5B. In short, a plurality of interfaces matching a plurality of engaging modes between the PC body 3 and the keyboard 4 are provided on both or either of the PC body 3 and the keyboard 4.

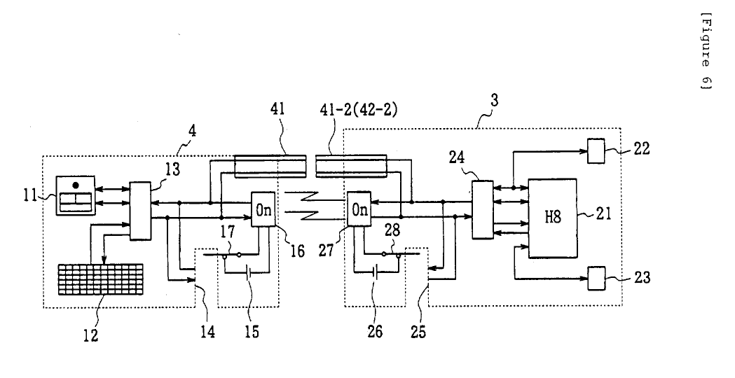

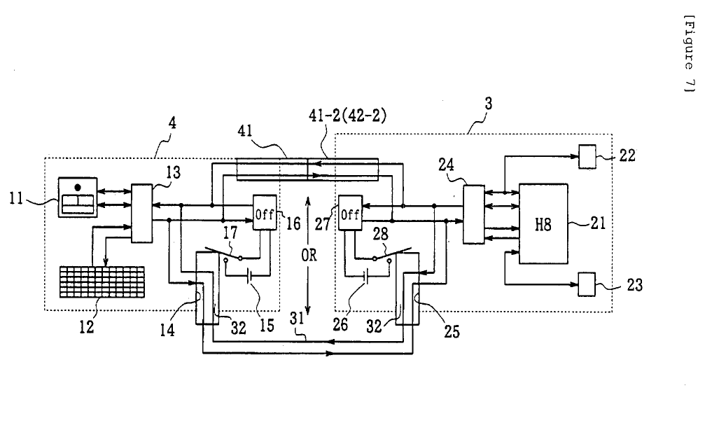

FIG. 6 and FIG. 7 are diagrams illustrating states of connection between the keyboard 4 and the PC body 3. In FIG. 6 and FIG. 7, the circuits are basically the same as their respective counterparts shown in FIG. 2 and FIG. 3, and denoted by the same reference numerals, and their description is, omitted. The example shown in FIG. 6 represents connection of the wireless system in the separated position, while the example shown in FIG. 7 represents the wired system in the connected position, the inclined position and the separated position.

The wireless system shown in FIG. 6 operates basically in the same way as the wireless system shown in FIG. 2. Where the wired system shown in FIG. 7 uses the cable 31 in the separated position, it operates in the same way as the wired system shown in FIG. 3. On the other hand, when the wired system shown in FIG. 7 is in the connected position or the inclined position, the role of the cable 31 is performed by the connector 41 and the connector 42-1 or 42-2. Thus, when it is in the connected position, the connector 41 and the connector 42-1 are connected, and when it is in the inclined position, the connector 41 and the connector 42-2 are connected. Other actions are the same as those of the wired system shown in FIG. 3. Of course, connection by the connector 41 and the connector 42-1 or 42-2 and connection by the cable 31 never take place at the same time. In the connected position and the inclined position, connection by the connector 41 and the connector 42-1 or 42-2 is used, and in the separated position, connection by the cable 31 is used. In this example, as the system is wired using the connectors always in the connected position or the inclined position but is never wireless, there is no consumption of power from the power source 15 by the keyboard 4.

As readily recognized by those skilled in the art, many of the exact details of the invention as described above may be varied without departing from the scope of the invention. In the drawings and specification above there have been set forth several preferred embodiments of the present invention, and, although specific terms are used, the description thus given uses terminology in a generic and descriptive sense only and not for purposes of limitation.

1. An electrical device comprising:
an electrical device body, and
an input unit configured to be detachable from the electrical device body and capable of communicating with the electrical device body in either a wired manner or a wireless manner.

2. The electrical device according to claim 1, wherein said input unit is configured so as to permit automatically switching between wired and wireless communication while in a state physically separated from the electrical device body by plugging or unplugging a cable.

3. The electrical device according to claim 1, wherein a wireless unit on the input unit side and a wireless unit on the electrical device body side are suspended from operation when the input unit is communicating with the electrical device body in a wired manner.

4. The electrical device according to claim 1, wherein the electric power for the input unit is supplied from the electrical device body via a cable when the input unit is communicating with the electrical device body in a wired manner.

5. The electrical device according to claim 1, wherein said electrical device body has a first interface for communicating with said input unit when said input unit engages said electrical device body in a first position and a second interface for communicating with said input unit when said input unit engages said electrical device body in a second position.

6. The electrical device according to claim 1, wherein said input unit has a first interface for communicating with said electrical device body when said input unit engages said electrical device body in a first position and a second interface for communicating with said electrical device body when said input unit engages said electrical device body in a second position.

7. The electrical device according to claim 5, wherein said first position is a position in which said input unit and said electrical device body are integrated with each other to be made portable.

8. The electrical device according to claim 5, wherein said second position is a position in which the electrical device is to be used with part of said input unit being engaged with part of said electrical device body and another part of said input unit being separated from said electrical device body.
